(19) United States
(12) Patent Application Publication
(10) Pub. No.: US 2014/0349664 A1
(43) Pub. Date: Nov. 27, 2014

(54) Methods and Apparati Which May Reuse Resources in Neighboring Cells

(71) Applicant: Nokia Solutions and Networks Oy, Espoo (FI)

(72) Inventors: Klaus Ingemann Pedersen, Aalborg (DK); Timo Erkki Lunttila, Espoo (FI); Frank Frederiksen, Klarup (DK)

(21) Appl. No.: 14/373,768

(22) PCT Filed: Jan. 25, 2012
(86) PCT No.: PCT/EP2012/051138

§ 371 Date: Aug. 13, 2014

(51) Int. Cl. H04W 16/16; H04W 36/06; H04W 28/20

(52) U.S. Cl. CPC H04W 16/16; H04W 28/20; H04W 36/06; H04W 84/045
USPC 455/450

(57) ABSTRACT

A method including configuring one or more reference signals and/or channels in a carrier bandwidth including one or more physical resource units; and causing information on the configuration of said one or more reference signals and/or channels to be provided to another base station using a same or overlapping carrier bandwidth.

The present invention relates to a method and apparatus and in particular but not exclusively to a method and apparatus in a communications network which may reuse resources in neighbouring cells.

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3^{rd} Generation Partnership Project (3GPP). The various development stages of the 3GPP LTE specifications are referred to as releases. A further development of the LTE is referred to as LTE-Advanced (LTE-A).

It has been proposed to install relatively low-power base stations. One example of such low-power base stations are “femto-cells” or Home NodeB (HNB) or home evolved node Bs (HeNB). Other examples of lower power base stations are pico or micro cells. Such low power base stations may be user deployed cellular base stations offering higher capacity for a given area as compared to macro cells. This is because the low power base stations use smaller cell sizes and may have more effective reuse of frequency.

According to an embodiment, there is provided a method comprising: configuring one or more reference signals and/or channels in a carrier bandwidth comprising one or more physical resource units; and causing information on the configuration of said one or more reference signals and/or channels to be provided to another base station using a same or overlapping carrier bandwidth.

The method may comprise causing said information to be provided during a set up procedure with said another base station.

The method may comprise causing said information to be provided during a configuration update procedure with another base station.

According to another embodiment, there is provided a method comprising: determining interference on one or more reference signals and/or channels in a carrier bandwidth comprising one or more physical resource units; and causing information on the determined interference on said one or more reference signals and/or channels to be provided to another base station using a same carrier bandwidth.

The method may comprise causing information to be provided comprises providing a request to said another base station, said request requesting said another base station changes one or more resources allocated to corresponding one or more reference signals and/or channels in said same carrier bandwidth.

The method may comprise causing information to be provided comprises providing a command to said another base station, said command commanding said another base station changes one or more resources allocated to corresponding one or more reference signals and/or channels in said same carrier bandwidth.

The method may comprise causing said information to be provided in a load information message.

According to another embodiment, there is provided a method comprising: receiving information on one or more reference signals and/or channels from a first base station using a same carrier bandwidth; and configuring or changing a corresponding one or more reference signals and channels to one or more different resources to that used in said first station.

According to another embodiment, there is provided a method comprising: causing information to be provided to one or more user equipment on resource allocation associated with one or more reference signals and/or channels used by a base station in a carrier bandwidth.

The method may comprise additionally causing information to be provided to said one or more user equipment on resource allocation of a corresponding one or more reference signals and/or channels used by another base station in said carrier bandwidth.

The one or more reference signals and/or channels may comprise one or more of the following: primary synchronisation signal; secondary synchronisation channel; common reference symbols; physical downlink control channel; physical hybrid automatic request-repeat indicator channel; physical control format indicator channel; and physical broadcast channel.

The information may comprise information on one or more physical resource blocks allocated to said one or more reference signals and/or channels.

The causing of information to be provided may comprise causing said information to be transmitted.

According to another embodiment, there is provided a computer program comprising computer executable instructions which when run cause one of the above methods of to be performed.

According to another embodiment, there is provided apparatus comprising: means for configuring one or more reference signals and/or channels in a carrier bandwidth comprising one or more physical resource units; and means for causing information on the configuration of said one or more reference signals and/or channels to be provided to another base station using a same or overlapping carrier bandwidth.

The causing means may be for causing said information to be provided during a set up procedure with said another base station.

The causing means may be for causing said information to be provided during a configuration update procedure with another base station.

According to another embodiment there is provided an apparatus comprising: means for determining interference on one or more reference signals and/or channels in a carrier bandwidth comprising one or more physical resource units; and means for causing information on the determined interference on said one or more reference signals and/or channels to be provided to another base station using a same carrier bandwidth.

The causing means may be for causing information to be provided is for providing a request to said another base station, said request requesting said another base station changes one or more resources allocated to corresponding one or more reference signals and/or channels in said same carrier bandwidth.

The causing means may be for causing information to be provided is for providing a command to said another base station, said command commanding said another base station changes one or more resources allocated to corresponding one or more reference signals and/or channels in said same carrier bandwidth.

The causing means may be for providing said information in a load information message.

According to another embodiment, there is provided apparatus comprising: means for receiving information on one or more reference signals and/or channels from a first base station using a same carrier bandwidth; and means for configuring or changing a corresponding one or more reference signals and channels to one or more different resources to that used in said first station.

According to another embodiment, there is provided apparatus comprising: means for causing information to be provided to one or more user equipment on resource allocation associated with one or more reference signals and/or channels used by a base station in a carrier bandwidth.

The causing means may be for additionally causing information to be provided to said one or more user equipment on resource allocation of a corresponding one or more reference signals and/or channels used by another base station in said carrier bandwidth.

The one or more reference signals and/or channels comprises one or more of the following: primary synchronisation signal; secondary synchronisation channel; common reference symbols; physical downlink control channel; physical hybrid automatic request-repeat indicator channel; physical control format indicator channel; and physical broadcast channel

The information may comprise information on one or more physical resource blocks allocated to said one or more reference signals and/or channels

A base station may comprise apparatus as described above.

According to another embodiment, there is provided apparatus, which may be provided in a user equipment, comprising: means for receiving information resource allocation associated with one or more reference signals and/or channels used by a base station in a carrier bandwidth.

According to another embodiment, there is provided an apparatus, said apparatus comprising at least one processor and at least one memory including computer program code, the at least one memory and computer program code configured to with the at least one processor cause the apparatus at least to: configure one or more reference signals and/or channels in a carrier bandwidth comprising one or more physical resource units; and cause information on the configuration of said one or more reference signals and/or channels to be provided to another base station using a same or overlapping carrier bandwidth.

The at least one memory and computer program code may be configured to with the at least one processor cause the apparatus to cause said information to be provided during a set up procedure with said another base station.

The at least one memory and computer program code may be configured to with the at least one processor cause the apparatus to cause said information to be provided during a configuration update procedure with another base station.

According to another embodiment, there is provided an apparatus, said apparatus comprising at least one processor and at least one memory including computer program code, the at least one memory and computer program code configured to with the at least one processor cause the apparatus at least to: determine interference on one or more reference signals and/or channels in a carrier bandwidth comprising one or more physical resource units; and cause information on the determined interference on said one or more reference signals and/or channels to be provided to another base station using a same carrier bandwidth.

The at least one memory and computer program code may be configured to with the at least one processor cause the apparatus to provide a request to said another base station, said request requesting said another base station changes one or more resources allocated to corresponding one or more reference signals and/or channels in said same carrier bandwidth.

The at least one memory and computer program code may be configured to with the at least one processor cause the apparatus to provide a command to said another base station, said command commanding said another base station changes one or more resources allocated to corresponding one or more reference signals and/or channels in said same carrier bandwidth.

The at least one memory and computer program code may be configured to with the at least one processor cause the apparatus to cause said information to be provided in a load information message.

According to another embodiment, there is provided an apparatus, said apparatus comprising at least one processor and at least one memory including computer program code, the at least one memory and computer program code configured to with the at least one processor cause the apparatus at least to; receive information on one or more reference signals and/or channels from a first base station using a same carrier bandwidth; and configure or change a corresponding one or more reference signals and channels to one or more different resources to that used in said first station.

According to another embodiment, there is provided an apparatus, said apparatus comprising at least one processor and at least one memory including computer program code, the at least one memory and computer program code configured to with the at least one processor cause the apparatus at least to; cause information to be provided to one or more user equipment on resource allocation associated with one or more reference signals and/or channels used by a base station in a carrier bandwidth.

The at least one memory and computer program code may be configured to with the at least one processor cause the apparatus to cause additional information to be provided to said one or more user equipment on resource allocation of a corresponding one or more reference signals and/or channels used by another base station in said carrier bandwidth.

The one or more reference signals and/or channels comprises one or more of the following: primary synchronisation signal; secondary synchronisation channel; common reference symbols; physical downlink control channel; physical hybrid automatic request-repeat indicator channel; physical control format indicator channel; and physical broadcast channel

The information may comprises information on one or more physical resource blocks allocated to said one or more reference signals and/or channels

Some embodiments will now be described, by way of example only, with reference to the following examples and accompanying drawings in which:

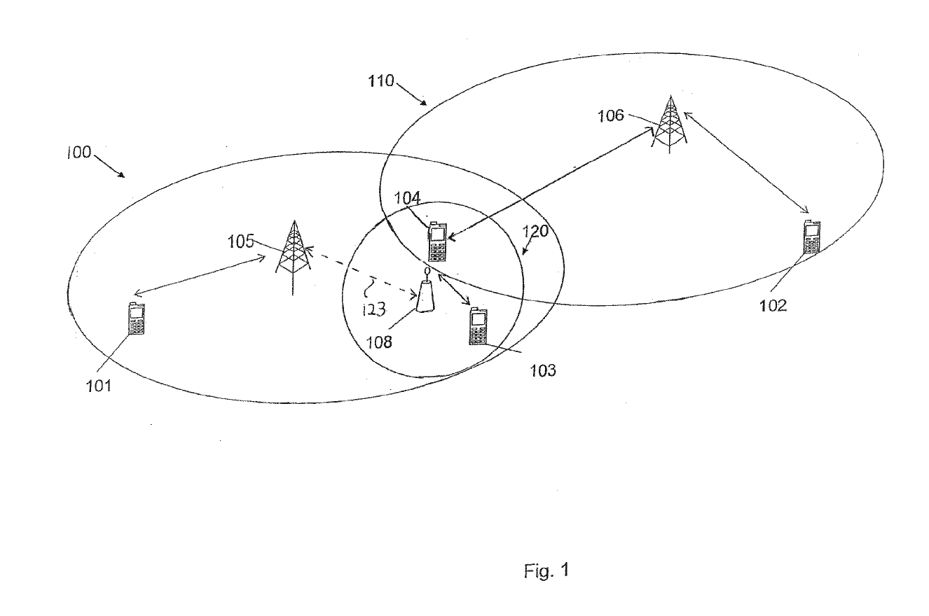

FIG. 1 shows a schematic diagram of a network according to some embodiments;

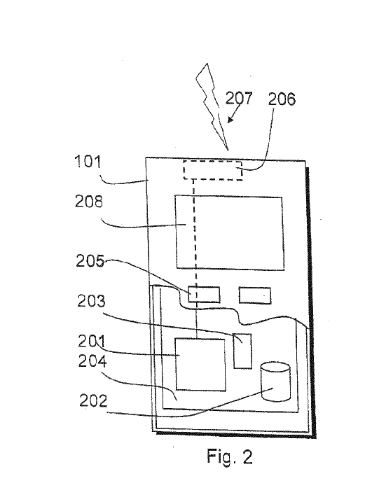

FIG. 2 shows a schematic diagram of a mobile communication device according to some embodiments;

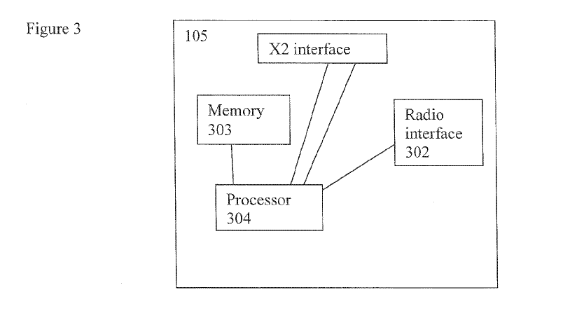

FIG. 3 shows a schematic diagram of a base station according to some embodiments;

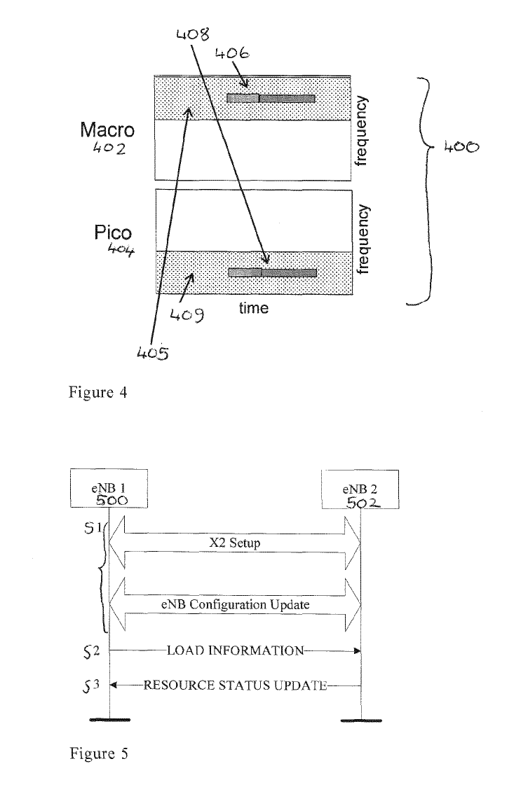

FIG. 4 shows a carrier configuration for a first and second cell;

FIG. 5 shows a signalling flow between a first and a second base station; and

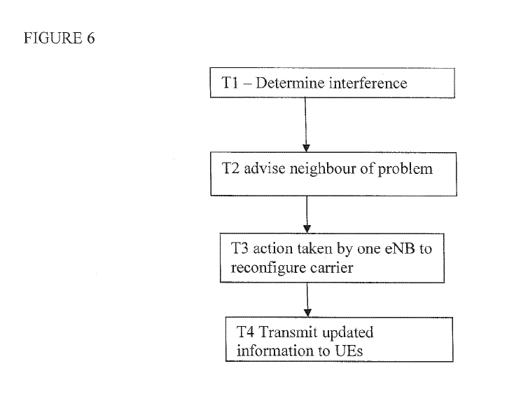

FIG. 6 shows a method.

In the following certain exemplifying embodiments are explained with reference to a wireless or mobile communication system serving mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

A mobile communication device or user equipment 101, 102, 103, 104 is typically provided wireless access via a base station or similar wireless transmitter and/or receiver node of an access system. In FIG. 1 three neighbouring and overlapping access systems or radio service areas 100, 110 and 120 are shown being provided by base stations 105, 106, and 108.

However, it is noted that instead of three access systems, any number of access systems can be provided in a communication system. An access system can be provided by a cell of a cellular system or another system enabling a communication device to access a communication system. A base station site 105, 106, 108 can provide one or more cells. A base station can also provide a plurality of sectors, for example three radio sectors, each sector providing a cell or a subarea of a cell. All sectors within a cell can be served by the same base station. A radio link within a sector can be identified by a single logical identification belonging to that sector. Thus a base station can provide one or more radio service areas.

The cell borders or edges are schematically shown for illustration purposes only in FIG. 1. It shall be understood that the sizes and shapes of the cells or other radio service areas may vary considerably from the similarly sized omni-directional shapes of FIG. 1.

In particular, FIG. 1 depicts two wide area base stations 105, 106, which can be macro-NBs (node B) 105, 106. The macro-NBs 105, 106 transmit and receive data over the entire coverage of the cells 100 and 110 respectively. FIG. 1 also shows a smaller base station or access point 108. The coverage of the smaller base station 108 may generally be smaller than the coverage of the wide area base stations 105, 106. The coverage provided by the smaller node 108 overlap with the coverage provided by the macro-NBs 105, 106. In some embodiments, the smaller node can be pico NB or a femto NB or a Home NodeB.

In some embodiments there may be a relatively large number of femto cells and/or pico cells near a user equipment although only one has been has been shown in FIG. 1 for illustrative purposes.

The communication devices 101, 102, 103, 104 can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

Non-limiting examples of appropriate access nodes are a base station of a cellular system, for example what is known as NodeB (NB) in the vocabulary of the 3GPP specifications. The LTE employs a mobile architecture known as the Evolved Universal Terrestrial Radio Access Network (E-UTRAN). Base stations of such systems are known as evolved Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices. Other examples of radio access system include those provided by base stations of systems that are based on technologies such as wireless local area network (WLAN) and/or WiMax (Worldwide Interoperability for Microwave Access).

The communication devices will now be described in more detail in reference to FIG. 2. FIG. 2 shows a schematic, partially sectioned view of a communication device 101 that a user can use for communication. The communication device may be a mobile communication device. A communication device is often referred to as user equipment (UE) or terminal. An appropriate communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. A user may also be provided broadcast or multicast data. Non-limiting examples of the content include downloads, television and radio programs, videos, advertisements, various alerts and other information.

The user equipment 101 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

The user equipment is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204.

The user may control the operation of the user equipment by means of a suitable user interface such as a key pad 205, voice commands, touch sensitive screen or pad, combinations thereof or the like. A display 208, a speaker and a microphone can be also provided. Furthermore, a user equipment may comprise appropriate connectors (either wired or wireless) to other devices and/or for connecting external accessories, for example hands-free equipment, thereto.

FIG. 3 shows an example of a base station. The base comprises at least one memory 303, at least one data processing unit 304, and X2 interface 301 for communicated with other base stations and a radio interface 302 for communicating with UEs. The base station can be configured to execute an appropriate software code to provide functions.

Heterogeneous networks (HetNet) have been proposed. A heterogeneous network has a macro cellular network which may be overlaid with one or more micro, pico and/or femto cells. The femto cells may be home femto cells which may be subject to unplanned deployment. Efficient interference management schemes are therefore desirable for the optimisation of HetNet cases.

In LTE Rel-8/9/10 carriers of different bandwidths are supported. These carriers range for example from 1.4 MHz to 20 MHz. With the current specification, these carriers have the same numerology and structure. Thus the sub-carrier spacing, symbol time, cycling prefix, physical resource block size, etc., may be the same for all carrier bandwidths.

A downlink carrier may for example have common reference symbols CRS and downlink control channels distributed over the full bandwidth in every sub-frame. These control channels may be PDCCH (physical downlink control channel), PHICH (physical hybrid ARQ (automatic repeat-request) indicator channel) and a PCFICH (physical control format indicator channel) channels.

Each carrier has cell system information such as PSS (primary synchronisation signal), SSS (secondary synchronisation signal) and PBCH (physical broadcast channel) transmitted on for example the six centre PRBs (physical resource blocks) on certain sub-frames. These signals are reference signals which allow a UE to determine time and frequency parameters which are used to demodulate down link signals, transmit signals with the correct timing and acquire system parameters.

In LTE, these signals may be used for initial synchronisation and at handovers. The PSS and SSS are used by a UE to perform time and frequency synchronization and acquire system parameters such as cell identity, cyclic prefix mode and access mode (either frequency division duplex FFD or time division duplex TDD). The UE can decode the PBCH at this stage and obtain system information.

The provision of these reference signals on the six centre PRBs may make the introduction of full resource partitioning between two interfering cells operating on the same bandwidth difficult to implement.

Resource partitioning may be advantageous for e.g. the HetNet case where it may be beneficial to have resource partitioning between a larger cell and a smaller cell to eliminate or reduce inter-layer (cell) interference.

By way of example only, the larger cell may be for example a macro cell and the smaller cell may be a micro, pico or femto/home eNodeB. However, it should be appreciated that embodiments may be used between any two suitable cells and in some embodiments may be used where the two cells are of similar size. Some embodiments may be useful where for example two or more cells are at least partially overlapping, completely overlapping or neighbouring.

It has been suggested to introduce a new carrier type in the 3GPP forum for LTE-A (Rel 11). This new carrier type may be able to provide improved spectral efficiency, improved support for the HetNet case and/or energy efficiency. In some embodiments, this new carrier type may reduce or eliminate legacy control signalling and/or the common reference signals CRS.

It has been suggested that common reference symbols be no longer used and instead reliance is more heavily placed on the channel state information reference signals (CSI-RS). However, this may be disadvantageous in some scenarios. The user equipment needs to base its synchronisation and time/frequency tracking procedures on some reference signals that are dense enough in both time and frequency. The currently defined CSI-RS designs may not be suitable to meet the necessary requirements, in some embodiments.

It has been proposed to provide a carrier type in which CRS are transmitted only on a fraction of the carrier resource space, for example on a sub-set of all sub-carriers. In this regard, reference is made to FIG. 4. The carrier bandwidth is defined as the CSI-RS bandwidth. The CSI-RS is a common signal spanning the whole bandwidth. FIG. 4 shows one example of a bandwidth 400. The bandwidth is partitioned into carriers 402 which are assigned to the larger cell, in this case a macro cell, and carriers referenced 404 which are assigned to the smaller cell, which in this example is the pico cell. The transmission of PSS, SSS and/or PBCH is such that the position of these signals and channel can be configured to certain PRBs per carrier. In other words, the PSS, SSS and PBCH do not always need to be transmitted on the six centre PRBs as previously proposed. Similarly the PDCCH, PHICH and PCFICH do not need to be transmitted on the six centre PRBs.

In the arrangement of FIG. 4, the macro and pico eNBs are configured to operate on the same bandwidth but have different carrier configurations. In the example shown in FIG. 4, the resource partitioning between the macro and pico cell for CRS and PSS, SSS and/or PCBH transmissions is implemented in the frequency domain. As can be seen from FIG. 4, the carrier used by the macro cell is configured to transmit CRS only on the upper part 409 of the carrier bandwidth. The pico cell is configured to transmit the CRS only on the lower part 405 of the carrier bandwidth.

Further, PSS, SSS and PBCH transmissions 406 and 408 from the macro and pico cells are configured to take place on the upper and lower parts of the carrier bandwidth respectively on complementary parts of the carrier bandwidth such that PSS, SSS and PBCH collisions are avoided between the pico and macro cells.

In the example shown in FIG. 4, a frequency domain partitioning is shown. However, alternative embodiments may be used in a time domain and/or combined time/frequency domain. For example, the CRS transmission per carrier may be flexibly configured to only happen on a limited time frequency resource space within the carrier bandwidth.

In embodiments, inter-eNB signalling, (for example between macro and pico cells) is needed to enable eNB self-configuration of carrier configurations to avoid interference problems between the eNBs. It should be appreciated that in some embodiments, carrier configuration may refer to the configuration of at least one of the CRS, PSS, SSS and PCB transmission per carrier.

Signalling between an eNB and user equipment may be provided in some embodiments to enable efficient system performance and mobility if the system consists of eNBs having CRS and PSS, SSS and/or PBCH transmissions on different resource regions per carrier or cell. Some embodiments may provide inter-eNB signalling and/or eNB to user equipment signalling to enable a simple and distributed mechanism for inter-cell interference co-ordination (ICC) of CRS and PSS, SSS and/or PBCH for co-channel deployment of LTE with a channel such as shown in FIG. 4.

Reference is made to FIG. 5 which shows an information exchange between a first eNodeB 500 and a second eNodeB 502. The first eNodeB 500 may for example be a macro eNodeB such as referenced 105 or 106 in FIG. 1. Likewise, the second eNodeB may be a pico or femto eNB as referenced 108 in FIG. 1. The interface between two eNBs in the 3GPP standard is referred to as the X2 interface. An X2 interface is shown between macro eNB 105 and the smaller eNB 108 and is referenced 123.

Some embodiments may be incorporated in some of the existing X2 specification signalling. By way of example only, reference is made to 3GPP TS36.423 which describes the known X2 specification.

In step S1 shown in FIG. 5, the X2 interface between the two eNBs is set up and the configuration update is performed.

The current X2 set up and configuration procedures involve the two eNBs exchanging information on which carriers or cells each eNB is currently using. Information on the number of antenna ports per carrier or cell is also exchanged. In some embodiments, one or more information elements may be provided which provide CRS, PSS/SSS/PBCH and/or CSI-RS configuration per carrier or cells. Thus, step S1 allows each eNodeB to inform its neighbouring cells how it has configured its carriers or cells. This will include information on how the CRS and PSS/SSS and/or PCH transmission has been configured per carrier. This information is used by the neighbouring eNodeBs to ensure that they configure their same carrier to have non-overlapping CRS and PSS/SSS/PBCH transmission configurations.

In some embodiments, one of the eNodeBs may be a master cell which will instruct a slave cell as to the configuration. Typically, the master cell would be a larger cell such as a macro cell and the slave cell would be a smaller cell such as a pico or femto cell.

In other embodiments, a final used configuration may be achieved as a result of negotiation between the two eNBs.

Some embodiments may provide a reactive interference management mechanism. This is described in relation to FIG. 6.

In step T1 an eNB determines that there is interference on the PSS/SSS/PBCH from the corresponding channel on a neighbouring eNB. It should be noted that the neighbouring eNB may be from an overlapping cell, a partially overlapping cell or a neighbouring cell. In some embodiments an eNB can detect PSS/SSS/PBCH interference problems via other X2 signalling. This may be used for other purposes such as SON (self-optimising networks) or MRO (mobility robustness optimisation). Part of the current MRO procedures includes some X2 signalling to indicate potential causes of handover failures. In some embodiments, this information can be used as input for at least partly detecting if a handover has failed because the UE could not correctly decode system information such as PSS/SSS/PBCH).

In step T2 the eNB advises a neighbouring eNB of the interference problem. This advice may comprise a request that the neighbouring eNB take the appropriate action to reduce the interference.

In one embodiment, an eNB is able to command or suggest that a neighbouring eNB changes one of its carrier configurations to transmit CRS and PSS/SSS/PBCH on a given set of resources or resource region. Alternatively, the eNB may change its carrier configuration and send this information to the other eNB.

If the two eNBs have colliding PSS, SSS and/or PBCH transmissions on the same carrier or cell, one possible action, as shown in step T3 is for one eNodeB to reconfigure their carrier to transmit PSS/SSS or PBCH at a different time and/or on frequency resources depending on the criteria for the domain portioning of the bandwidth.

Referring back to FIG. 5, step S2 comprises sending load information from the first eNB 500 to the second eNB 502. The second eNB 502 responds in step S3 with the resource status update. In one embodiment, the load information may comprise information from the first eNB requesting the second eNB to move its PSS, SSS and/or PBCH transmissions. Alternatively or additionally, the first eNB 500 may include a command or suggestion for new resources to be used by the second eNB for the CRS and/or PSS, SSS, and/or PBCH.

The resource status update may include information indicating a positive or negative response to the command and/or a proposed set of resources and/or information indicating the resources which have been selected.

It should be appreciated that this is only one example of how the information may be exchanged between the two eNBs and alternative embodiments may use any other suitable mechanism for information being exchanged.

In some embodiments, an eNB needs to signal to one or more UE about the change in the CRS and/or PSS/SSS/PBCH. This is shown in step T4 of FIG. 6. In one embodiment, the changes are broadcast per cell using radio resource control RRC or by any other suitable mechanism.

Thus, the eNB should be able to inform its UEs at which resources or resource regions CRS and PSS/SSS/PBCH as well as CSI-RS are transmitted. This information is used by the UE for performing own cell RRM (radio resource management) measurements, RLM (radio link monitoring) measurements and for receiving cell system information updates.

eNB may also inform its user equipment at which resources (or resource regions) CRS, PSS, SSS and/or PBCH and/or CSI-RS is transmitted at neighbouring cells. This information may be used by those user equipment when performing other cell RRM measurements and for synchronising to those cells. In some embodiments, providing this information to UEs may ensure that efficient mobility is maintained as a UE does not have to perform extensive search on the neighbouring cells to first establish where CRS and PSS/SSS/PBCH is transmitted.

In one embodiment the signalling of resource positions of neighbouring cells CRS and PSS/SSS/PBCH transmissions may be performed separately per PCI (physical cell identity) interval. This may be advantageous if, for example, macro and pico eNBs are configured to use different CRS and PSS/SSS/PBCH configurations and different PCI ranges.

In embodiments, the signalling provided may form a simple framework for co-ordinated carrier configuration of CRS and PSS/SSS/PBCH transmission. Some embodiments may be easily deployed for HetNet deployments.

Some embodiments may have the advantage that if the UEs are aware of the carrier configurations CRS and PSS, SSS and/or PBCH transmission, efficient and timely mobility may be maintained as UEs do not have to search blindly for those signals on each carrier or cell before it can perform RRM measurements.

The physical broadcast channel is a transmission channel that is used to transfer information to all UEs that are operating in a radio coverage area or cell. The broadcast channel periodically sends system identification and access control parameters. By way of example only, this information may be sent every 40 ms.

LTE uses a hierarchical cell search procedure. An LTE radio cell is identified by a cell identity. A UE will look for the primary synchronisation symbol PSS first. This may in some embodiments be transmitted in the last OFDM symbol of a first time slot of a first time sub-frame in a radio frame. This may be to enable a UE to acquire information on a slot boundary. In some embodiments, the primary synchronisation signal may be transmitted twice in a radio frame. In some embodiments, this means that the PSS is repeated in sub-frame 5, in timeslot 11. In some embodiments, a UE may be synchronised on a 5 ms basis.

Once the UE has found the 5 ms timing, the next stage is to obtain information on the radio frame timing and the cell group identity. This information is provided in the SSS. The SSS may also be transmitted every 5 milliseconds. This information may be transmitted in the symbol before the PSS. This means that the SSS may be transmitted in the first and fifth sub-frames, sub-frames 0 and 5.

Thus, PSS provides slot timing detection and physical layer ID. The SSS detection may provide radio frame timing detection, cyclic prefix length, cell ID detection and TDD/FDD detection.

In a TDD cell, the PSS may be located in the third symbol of the 3rd and 13th slots whilst the SSS is located at three symbols earlier.

Of course in alternative embodiments, the PSS and SSS may be located in alternative positions.

Embodiments have been described in relation to CRS, PSS, SSS and PBCH signals or channels. Alternative embodiments may be used with only one or some of these signals or channels.

Some embodiments may additionally or alternatively be used with one or more of PDCCH, PHICH and PCFICH.

Embodiments may be used in LTE, WCDMA systems or any other suitable systems.

Embodiments may be used in any suitable situation for example, be used where there are a number of smaller cells, such as femto, macro and/or pico cells.

Embodiments may be used in alternative systems, for example other OFDM systems.

Embodiments may be used with systems other than the LTE-A system. Accordingly, one or more of the reference signals/channels described may be replaced by one or more alternative reference signals.

Various different embodiments have been described. It should be appreciated that one or more embodiments may be used at least partially in combination.

Various different methods have been shown. It should be appreciated that in some embodiments one or more of the method steps may be combined into a single step. In some embodiments, one or more of the method steps may be changed in terms of order. In some embodiments, one or more steps may be omitted. In some embodiments, one or more additional steps may be included.

One or more of the steps of any of the methods may be implemented using a respective arrangement. The respective arrangement may comprise circuitry and/or may be performed by one or more processors run computer code. One or more arrangements may be provided by common circuitry and/or the same one or more processors as used by another arrangement. Where one or more processors are provided, these processors may operate in conjunction with one or more memories.

The required data processing apparatus and functions of a base station apparatus, and user equipment may be provided by means of one or more data processors. These may perform one or more of the method steps of a respective method.

The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip.

Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of embodiments may be implemented in hardware, while other aspects may be implemented in firmware or software which may be executed by a controller, microprocessor or other computing device, although embodiments are not limited thereto. While various aspects of the embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Some embodiments may be implemented by computer software executable by one or more data processors in conjunction with one or more memories of a base station, or UE.

One or more steps of a method of an embodiment may be performed when computer executable instructions are run on one or more processors.

Further in this regard it should be noted that any blocks of the logic flow as in the Figures may represent program steps, or interconnected logic circuits, blocks and functions, or a combination of program steps and logic circuits, blocks and functions.

The software or computer executable instructions may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method comprising:
configuring one or more reference signals and/or channels in a carrier bandwidth comprising one or more physical resource units; and
causing information on the configuration of said one or more reference signals and/or channels to be provided to another base station using a same or overlapping carrier bandwidth.

2. A method as claimed in claim 1, comprising causing said information to be provided during a set up procedure with said another base station.

3. A method as claimed in claim 1, comprising causing said information to be provided during a configuration update procedure with another base station.

4. A method comprising:
determining interference on one or more reference signals and/or channels in a carrier bandwidth comprising one or more physical resource units; and
causing information on the determined interference on said one or more reference signals and/or channels to be provided to another base station using a same carrier bandwidth.

5. A method as claimed in claim 4, wherein causing information to be provided comprises providing a request to said another base station, said request requesting said another base station changes one or more resources allocated to corresponding one or more reference signals and/or channels in said same carrier bandwidth.

6. A method as claimed in claim 4, wherein causing information to be provided comprises providing a command to said another base station, said command commanding said another base station changes one or more resources allocated to corresponding one or more reference signals and/or channels in said same carrier bandwidth.

7. A method as claimed in claim 1, comprising causing said information to be provided in a load information message.

8. A method comprising:
receiving information on one or more reference signals and/or channels from a first base station using a same carrier bandwidth; and
configuring or changing a corresponding one or more reference signals and channels to one or more different resources to that used in said first station.

9. A method comprising:
causing information to be provided to one or more user equipment on resource allocation associated with one or more reference signals and/or channels used by a base station in a carrier bandwidth.

10. A method as claimed in claim 9, comprising additionally causing information to be provided to said one or more user equipment on resource allocation of a corresponding one or more reference signals and/or channels used by another base station in said carrier bandwidth.

11. A method as claimed in claim 1, wherein said one or more reference signals and/or channels comprises one or more of the following:
primary synchronisation signal; secondary synchronisation channel; common reference symbols; physical downlink control channel; physical hybrid automatic request-repeat indicator channel; physical control format indicator channel; and physical broadcast channel

12. A method as claimed in claim 1, wherein said information comprises information on one or more physical resource blocks allocated to said one or more reference signals and/or channels

13. A computer program comprising computer executable instructions which when run cause the method of claim 1 to be performed.

14. Apparatus comprising:
means for configuring one or more reference signals and/or channels in a carrier bandwidth comprising one or more physical resource units; and
means for causing information on the configuration of said one or more reference signals and/or channels to be provided to another base station using a same or overlapping carrier bandwidth.

15. Apparatus as claimed in claim 14, wherein said causing means is for causing said information to be provided during a set up procedure with said another base station.

16. Apparatus as claimed in claim 14, wherein said causing means is for causing said information to be provided during a configuration update procedure with another base station.

17. Apparatus comprising:
means for determining interference on one or more reference signals and/or channels in a carrier bandwidth comprising one or more physical resource units; and
means for causing information on the determined interference on said one or more reference signals and/or channels to be provided to another base station using a same carrier bandwidth.

18. Apparatus as claimed in claim 17, wherein said means for causing information to be provided is for providing a request to said another base station, said request requesting said another base station changes one or more resources allocated to corresponding one or more reference signals and/or channels in said same carrier bandwidth.

19. Apparatus as claimed in claim 17, wherein said means for causing information to be provided is for providing a command to said another base station, said command commanding said another base station changes one or more resources allocated to corresponding one or more reference signals and/or channels in said same carrier bandwidth.

20. Apparatus as claimed in claim 14, wherein said means for causing is for providing said information in a load information message.

21. Apparatus comprising:
means for receiving information on one or more reference signals and/or channels from a first base station using a same carrier bandwidth; and
means for configuring or changing a corresponding one or more reference signals and channels to one or more different resources to that used in said first station.

22. Apparatus comprising:
means for causing information to be provided to one or more user equipment on resource allocation associated with one or more reference signals and/or channels used by a base station in a carrier bandwidth.

23. Apparatus as claimed in claim 22, wherein said means for causing is for additionally causing information to be provided to said one or more user equipment on resource allocation of a corresponding one or more reference signals and/or channels used by another base station in said carrier bandwidth.

24. Apparatus as claimed in claim 14, wherein said one or more reference signals and/or channels comprises one or more of the following:
Primary synchronisation signal; secondary synchronisation channel; common reference symbols; physical downlink control channel; physical hybrid automatic request-repeat indicator channel; physical control format indicator channel; and physical broadcast channel.

25. Apparatus as claimed in claim 14, wherein said information comprises information on one or more physical resource blocks allocated to said one or more reference signals and/or channels.

26. A base station comprising apparatus as claimed in claim 14.
